(19) United States
(12) Patent Application Publication
(10) Pub. No.: US 2014/0145957 A1
(43) Pub. Date: May 29, 2014

(54) RECEIVER DEVICE AND OPERATION METHOD THEREOF

(71) Applicant: PIXART IMAGING INC., Hsin-Chu City (TW)

(72) Inventors: Chun-Wei Chen, Hsin-Chu City (TW); Shih-Wei Kuo, Hsin-Chu City (TW)

(73) Assignee: PIXART IMAGING INC., Hsin-Chu City (TW)

(21) Appl. No.: 13/746,334

(22) Filed: Jan. 22, 2013

(30) Foreign Application Priority Data
Nov. 29, 2012 (TW) 101144725

(51) Int. Cl. G06F 3/0354

(52) U.S. Cl. CPC G06F 3/03543
USPC 345/166

(57) ABSTRACT

A receiver device receives a wireless signal and an image signal. The wireless signal is outputted from an input device to control a terminal device. The receiver device includes a receiver, a light source, an image detector and a processor. The receiver can receive the wireless signal. The light source emits a beam, and the beam is reflected by an external object to form the image signal. The image detector continuously receives the image signals. The processor is electrically connected to the receiver and the image detector. The processor can respectively transmit the wireless signal and the image signal to the terminal device.

### BACKGROUND OF THE INVENTION

1. Field of the Invention

The present invention relates to a receiver device of the mouse, and more particularly, to a receiver device and a related signal transmission method capable of receiving the wireless signal of the mouse and the image signal of the gesture.

2. Description of the Prior Art

A conventional mouse apparatus includes a wireless mouse and a receiver. The receiver is electrically connected to the computer host via the PS/2 connector or the USB connector. The wireless mouse can output a wireless signal, the receiver receives the wireless signal and transfers the wireless signal to the computer host, so as to drive the computer host to execute the application program. The conventional mouse apparatus only receives the wireless signal outputted from the wireless mouse. Therefore, design of a wireless mouse apparatus having expandable applying function is an important issued in the computer industry.

### SUMMARY OF THE INVENTION

The present invention provides a receiver device and a related signal transmission method capable of receiving the wireless signal of the mouse and the image signal of the gesture for solving above drawbacks.

According to the claimed invention, a receiver device for receiving a wireless signal and an image signal is disclosed. An input device outputs the wireless signal to control a terminal device. The receiver device includes a receiver, a light source, an image detector and a processor. The receiver receives the wireless signal. The light source emits a beam, and the beam is reflected by an external object to form the image signal. The image detector continuously receives the image signals. The processor is electrically connected to the receiver and the image detector for respectively transmitting the wireless signal and the image signal to the terminal device.

According to the claimed invention, a method of respectively transmitting a plurality of signals to a terminal device is disclosed. The method includes receiving a wireless signal, emitting a beam, receiving image signals continuously, and transmitting the wireless signal and the image signal to the terminal device respectively. An input device outputs the wireless signal to control the terminal device, and the beam is reflected by an external object to form the image signal.

The receiver device of the present invention includes the receiver for receiving the wireless signal and the image detector for receiving the reflection image signal from the external object. The receiver device can respectively transmit the wireless signal and the continuous image signals to the terminal device by scheduling for analysis procedure, and pre-read the image signal to switch the optical application programs of the terminal device accordingly. Therefore, the received device of the present invention can receive the wireless signal and capture the image signal, so the user can control the terminal device by the receiver device of the present invention in a wireless mouse manner, a gesture remote-controlled manner and a fingerprint analyzing manner.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a receiver device according to an embodiment of the present invention.

FIG. 2 is a diagram of a receiver device, an input device and a terminal device according to the embodiment of the present invention.

FIG. 3 is a flow chart of respectively transmitting the plurality of signals to the terminal device according to the embodiment of the present invention.

### DETAILED DESCRIPTION

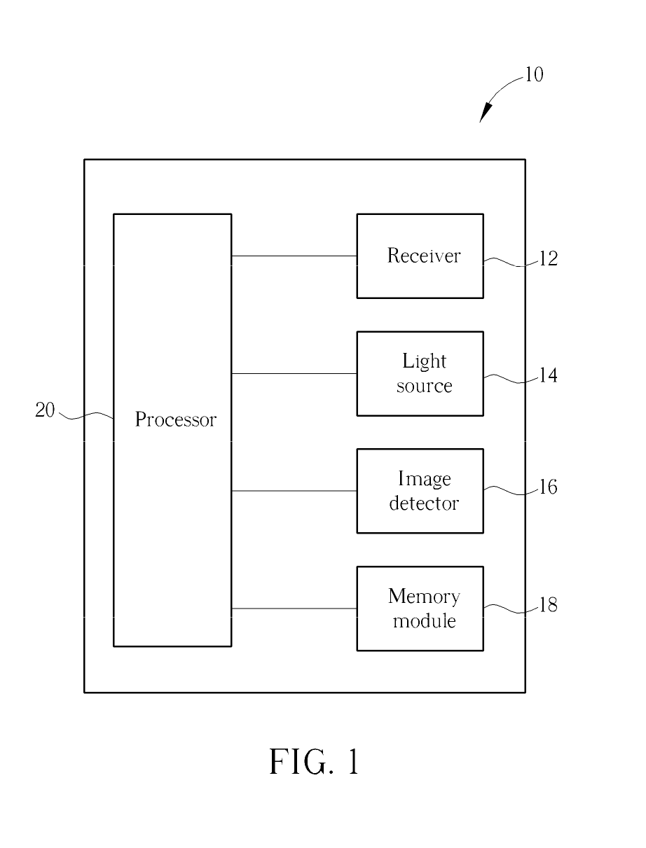

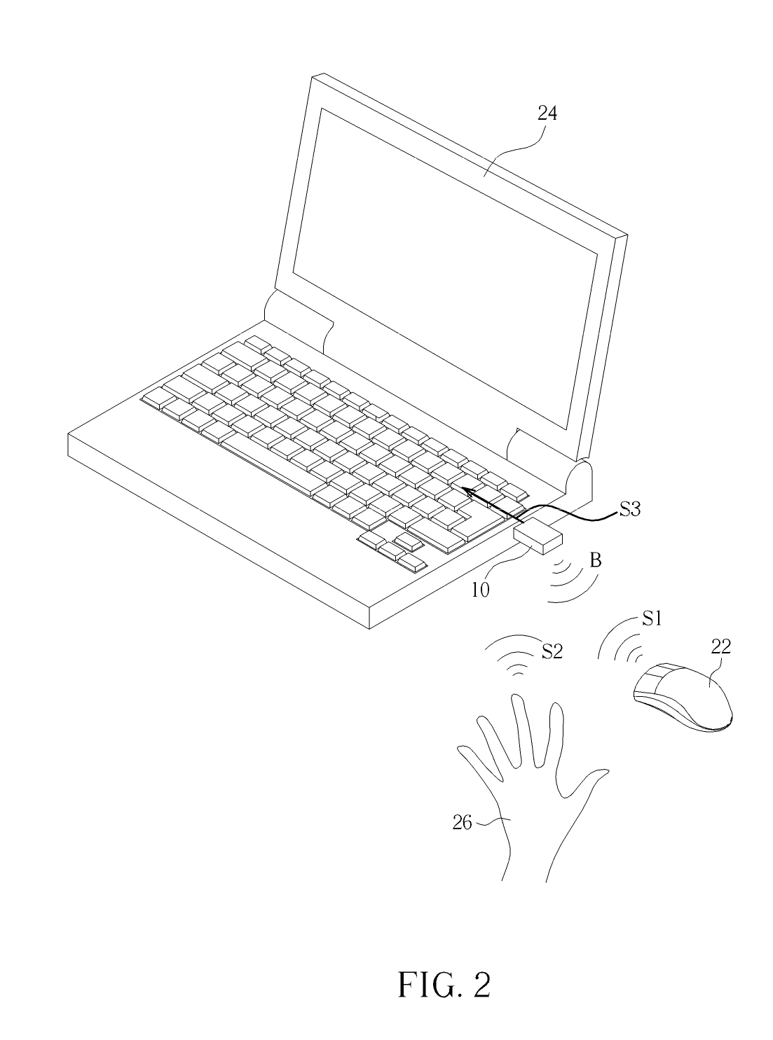

Please refer to FIG. 1. FIG. 1 is a functional block diagram of a receiver device 10 according to an embodiment of the present invention. The receiver device 10 includes a receiver 12, a light source 14, an image detector 16, a memory module 18 and a processor 20. The receiver device 10 can receive a wireless signal S1 outputted by an input device 22, so as to control operation of a terminal device 24. Please refer to FIG. 2. FIG. 2 is a diagram of the receiver device 10, the input device 22 and the terminal device 24 according to the embodiment of the present invention. The receiver device 10 can further receive an image signal S2, and control operation of the terminal device 24 according to an analyzing result of the image signal S2. For example, the input device 22 can be a wireless mouse, and the terminal device 24 can be a computer host. The receiver device 10 is a signal receiver detachably installed on the computer host. The receiver device 10 can receive the wireless signal S1 outputted by the wireless mouse or gesture by the user, to drive the computer host to execute the corresponding application program.

As shown in FIG. 1, the receiver 12 can receive the wireless signal S1 outputted by the input device 22, which is operated by the user. For example, the wireless signal S1 can be rolling information of the roller, a movement of cursor or click information of the keyswitch when the input device 22 is the wireless mouse. The light source 14 can emit a beam B, which can be visible light or invisible light. As the user shakes the hand within projection range of the beam B, the beam B can be reflected by the palm to form the image signal S2. Generally, the image signals S2 received by the receiver device 10 are mostly formed by the palm. However, the receiver device 10 of the present invention can further receive the image signal S2 formed by any reflection of the external object 26. In addition, the image detector 16 can receive the image signal S2, and the memory module 18 can store the basic command that is utilized by the processor 20.

The processor 20 is electrically connected to the receiver 12, the light source 14, the image detector 16 and the memory module 18. The processor 20 can actuate signal receiving function of the receiver 12, and transmit the wireless signal S1 to the terminal device 24 when the receiver 12 receives the wireless signal S1. The controller of the terminal device 24 can execute the application program by analysis of the wireless signal S1. Radiation intensity and projection range of the beam B can be adjusted according to user's demand. The processor 20 can drive the light source 14 to emit the beam B and drive the image detector 16 to receive the image signal S2 simultaneously when the receiver 12 is actuated. It should be mentioned that the image detector 16 can read a movement track of the external object 26. The image detector 16 can continuously receive a series of image signals S2, the processor 20 can transmit the continuous image signals S2 to the terminal device 24 accordingly, and the controller of the terminal device 24 can execute the corresponding application program according to analysis if the continuous image signals S2.

As the receiver 12 receives the wireless signal S1, the image detector 16 does not detect the image signal S2. As the image detector 16 receives the image signal S2, the receiver 12 does not detect the wireless signal S1. However, the processor 20 can respectively transmit the wireless signal S1 and the continuous image signals S2 to the terminal device 24 by scheduling when the receiver device 10 simultaneously receives the wireless signal S1 and the continuous image signals S2. For example, the processor 20 can send the image signal S2 at an interval between the adjacent wireless signals S1, or send the wireless signal S1 at the interval between the adjacent continuous image signals S2, so as to increase the signal transmission efficiency.

The receiver device 10 of the present invention can be a fingerprint recognizer or an optical finger mouse. For accurately switching applications of the image detector 16 of the receiver device 10, the processor 20 can analyze the continuous image signal S2 to determine motion of the external object 26 and to generate the corresponding control command S3. For example, a vision field of the image detector 16 can be substantially smaller than 2 centimeter in every direction of the vision field when the receiver device 10 executes the fingerprint recognition. The receiver device 10 reads the movement track of the external object 26 that is close to the image detector 16, so as to conform the user's habit. When the external object 26 moves within the vision field of the image detector at the unitary direction, the processor 20 can recognize the unitary-directional movement track of the external object 26 to determine that the external object 26 intends for the fingerprint recognition, so the processor 20 can drive the terminal device 24 to analyze the received continuous image signals S2 according to the control command S3, to recognize the surface feature (feature of the fingerprint) of the external object 26 displayed on the continuous image signals S2.

Furthermore, the vision field of the mage detector 16 can be substantially smaller than 15 centimeter in every direction of the vision field for adequate operation space when the receiver device 10 is the optical finger mouse. Movements of the external object 26 inside the operation space can be the control gesture for the optical finger mouse. When the external object 26 moves within the vision field of the image detector 16 at the multiple directions, the processor 20 can recognize the multiple-directional movement track of the external object 26 to determine what function of the optical finger mouse is actuated by the external object 26. Therefore, the processor 20 can drive the terminal device 24 to analyze the received continuous images signals S2 according to the control command S3, so as to recognize the movement information of the external object 26 displayed on the continuous image signals S2. The optical finger mouse can execute the movement calculation, direction recognition and keyswitch/roller detection of the external object 26, to control the application programs of the terminal device 24. The receiver device 10 can further be manually switched to the fingerprint recognition mode or the optical finger mouse mode via the terminal device 24.

The receiver device 10 of the present invention can have a safety lock function. The memory module 18 can further store at least one surface feature, such as the fingerprint of the user. Only the allowable member can operate the terminal device 24 due to utilization of the fingerprint recognition by the receiver device 10. As the image detector 16 receives the continuous image signals S2 and the movement track of the external object 26 represents the fingerprint recognition (which is analyzed by the processor 20), the processor 20 can connect to the memory module 18 to read the predetermined surface feature, and compare the continuous image signals S2 to the predetermined surface feature. The continuous image signals S2 does not conform to the predetermined surface feature, the receiver device 10 does not transmit the wireless signal S1 and the image signal S2 to the terminal device 24. The continuous image signals S2 conforms to the predetermined surface feature, the receiver device 10 can switch on or switch off the input device 22 accordingly, and the receiver device 10 can respectively transmit the received wireless signal S1 and the received image signal S2 to the terminal device 24. Further, the processor 20 can analyze the continuous image signals S2 to switch the image analyzing application program of the terminal device 24 via the control command S3.

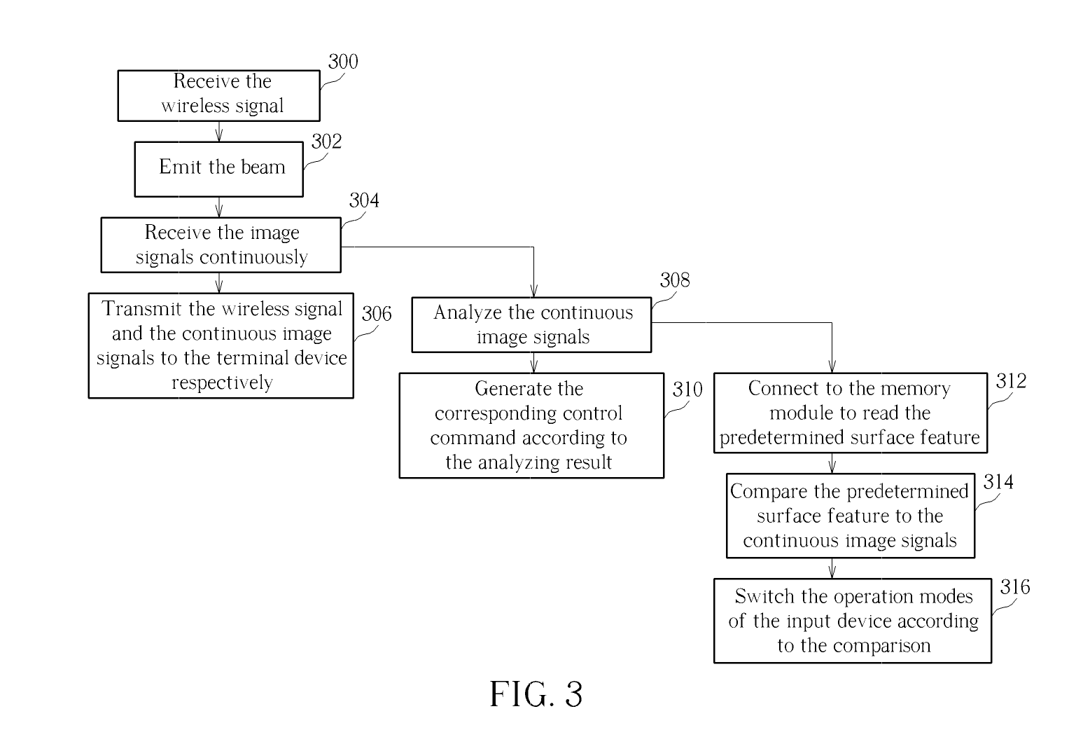

Please refer to FIG. 3. FIG. 3 is a flow chart of respectively transmitting the plurality of signals to the terminal device 24 according to the embodiment of the present invention. The method shown in FIG. 3 is applied to the receiver device 10 shown in FIG. 1 and FIG. 2. First, step 300 is executed to drive the receiver 12 to receive the wireless signal S1 by the processor 20. The wireless signal S1 can be information outputted from the input device 22. Then, step 302 is executed to drive the light source 14 to emit the beam B by the processor 20. The beam B is reflected by the external object 26 to form the image signal S2. Then, step 304 is executed to drive the image detector 16 to continuously receive the image signals S2 by the processor 20. The image signal S2 includes the movement track of the external object 26. Final, step 306 is executed to respectively transmit the wireless signal S1 and the continuous image signals S2 to the terminal device 24 by the processor 20.

The terminal device 24 can execute the correct application program by analysis of the continuous image signals S2. Step 308 and step 310 are executed to analyze the continuous image signals S2 and to generate the corresponding control command S3 according to the analyzing result by the processor 20. The control command S3 can switch the image analyzing application programs of the terminal device 24. For example, the terminal device 24 can analyze the continuous image signals S2 to acquire the surface feature of the external object 26 (such as the fingerprint image) when the terminal device 24 executes the fingerprint recognition. The terminal device 24 further can analyze the continuous image signals S2 to acquire the movement information of the external object 26 (such as the gesture variation of the user) when the terminal device 24 is operated by the optical finger mouse, and the movement information can be transformed to the control command for the operation of the terminal device 24.

After the processor 20 analyzes the continuous image signal S2, step 312 is executed to drive the processor 20 to connect to the memory module 18 for reading the predetermined surface feature. Then, step 314 and step 316 are executed to comparing the predetermined surface feature to the continuous image signals S2, and to switch the operation modes of the input device 22 (or the terminal device 24) by the processor 20. For example, the input device 22 (or the terminal device 24) can be switched on and switched off according to the comparison. Thus, the receiver device 10 of the present invention not only can receive the wireless signal S1 from the remote-controlled mouse, but also can integrate the image applications to provide functions of the optical finger mouse and the fingerprint recognition by analysis of the continuous image signals S2.

Comparing to the prior art, the receiver device of the present invention includes the receiver for receiving the wireless signal and the image detector for receiving the reflection image signal from the external object. The receiver device can respectively transmit the wireless signal and the continuous image signals to the terminal device by scheduling for analysis procedure, and pre-read the image signal to switch the optical application programs of the terminal device accordingly. Therefore, the received device of the present invention can receive the wireless signal and capture the image signal, so the user can control the terminal device by the receiver device of the present invention in a wireless mouse manner, a gesture remote-controlled manner and a fingerprint analyzing manner.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A receiver device for receiving a wireless signal and an image signal, an input device outputting the wireless signal to control a terminal device, the receiver device comprising:
a receiver for receiving the wireless signal;
a light source for emitting a beam, the beam being reflected by an external object to form the image signal;
an image detector for continuously receiving the image signals; and
a processor electrically connected to the receiver and the image detector for respectively transmitting the wireless signal and the image signal to the terminal device.

2. The receiver device of claim 1, wherein the processor further analyzes the continuous image signals to generate a corresponding control command.

3. The receiver device of claim 2, wherein the control command drives the terminal device to analyze the continuous image signals so as to acquire movement information of the external object.

4. The receiver device of claim 3, wherein a vision filed of the image detector is substantially smaller than 15 centimeter in every direction of the vision field.

5. The receiver device of claim 2, wherein the control command drives the terminal device to analyze the continuous image signals so as to acquire surface feature of the external object.

6. The receiver device of claim 5, wherein a vision field of the images detector is substantially smaller than 2 centimeter in every direction of the vision field.

7. The receiver device of claim 1, further comprising:
a memory module electrically connected to the processor, at least one surface feature being stored inside the memory module, the processor comparing the continuous image signals to the surface feature.

8. The receiver device of claim 7, wherein the input device is switched on and switched off by the processor according to a comparison.

9. A method of respectively transmitting a plurality of signals to a terminal device, the method comprising:
receiving a wireless signal;
emitting a beam;
receiving image signals continuously; and
transmitting the wireless signal and the image signal to the terminal device respectively;
wherein an input device outputs the wireless signal to control the terminal device, and the beam is reflected by an external object to form the image signal.

10. The method of claim 9, further comprising:
analyzing the continuous image signals; and
generating a corresponding control command according to an analyzing result.

11. The method of claim 10, wherein an application program of the terminal device is switched by the control command.

12. The method of claim 10, wherein the control command drives the terminal device to analyze the continuous image signals so as to acquire movement information and surface feature of the external object.

13. The method of claim 12, wherein a vision field of the image detector is substantially smaller than 15 centimeter in every direction of the vision field when the terminal device analyzes the movement information of the external object.

14. The method of claim 12, wherein a vision field of the image detector is substantially smaller than 2 centimeter in every direction of the vision field when the terminal device analyzes the surface feature of the external object.

15. The method of claim 9, further comprising:
connecting to a memory module to acquire at least one surface feature;
comparing the continuous image signals to the surface feature; and
switching an operational mode of the input device according to a comparison.

16. The method of claim 15, wherein switching the operational mode of the input device comprises switching on the input device or switching off the input device.
